(19) United States
(12) Patent Application Publication
(10) Pub. No.: US 2005/0028626 A1
(43) Pub. Date: Feb. 10, 2005

(54) Gear reduction unit

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 10/633,763

(22) Filed: Aug. 4, 2003

(51) Int. Cl. F16H 1/12

(52) U.S. Cl. 74/416

(57) ABSTRACT

A gear reduction unit is provided with a unique combination of right angle gears with means for distinct connection of pinions with independent shaft. The gear reduction unit has many variations with different types of right angle gears, according with the desired numbers of ratios and torque and size requirements. The gear reduction unit is more efficient, quite and more compact than conventional parallel shaft or planetary systems which have been typically used in power regulating transmissions. The gear reduction unit of the present invention is easily manufactured.

### FIELD OF THE INVENTION

The present invention relates to a gear apparatus, particularly to multi speed gear transmissions for mechanical energy regulation. They are used to reduce or to increase speed or increase or reduce torque in helicopter or automobile gearboxes, turbine gearboxes, ship's transmission, and industrial applications. Certain applications may be outside of these fields, like power windows, doors or seats, power steering systems, chainless bicycle or motorcycle transmissions, and much more.

### BACKGROUND OF THE INVENTION

A right angle gear transmission is well known for the transformation of motion and power between shafts where the axis of the pinion and the gear may be crossed or intersected.

Common multi speed gearboxes include first and secondary gear assemblies, each having a driving member and a driven follower member. In low ratio gearboxes, gear assembly usually uses spur gears, and for highest ratios or for more variations of ratio, gearboxes have additional countershaft with additional gear assemble. Another choice for multi speed gearboxes involves using planetary gear sets consisting mostly of the following elements: ring gear, sun gear and planetary carrier cage. To have multi speed right angle transmission a combination of right angle gear set and multi speed transmission with parallel shafts is used. It makes multi speed right angle gearbox complicated and larger, while reducing efficiency and producing more noise.

Right angle gears are known to be used where these gears are coaxially arranged and connected to each other to transfer power with unchangeable ratio. In the Saari patent (U.S. Pat. No. 2,908,187) relatively large face-type worm gears and second and relatively smaller similar face-type worm gears coaxially are fixed to the output and one worm in mesh with large worm gear with second worm in mesh with smaller worm gear are fixed to an input shaft.

In multiplex bevel gearing by Kirsten (U.S. Pat. No. 2,418,555) two members rotating about axes disposed angulary relative to each other consisting of plurality of pinions permanently connected to one shaft in mesh with plurality of position adjustable bevel gears, also connected to one output. In the patent bevel gears transmit power simultaneously.

According with Gleason (U.S. Pat. No. 1,848,342) a tapered gear comprising a rotation unit of outer and inner members in mesh with another rotating unit of pinions connected to a shaft.

### SUMMARY OF THE INVENTION

Right angle gears have very wide use in many applications. Right angle gears for the same size of the pinion and the same ratio have almost twice the torque capacity of traditional parallel shaft gearing. When it is necessary to change gear ratio a combination of right angle gears attached to variable or changeable ratio gears with parallel shafts is usually used. Present invention makes right angle multi speed gear boxes more simple and efficient, with a more compact design. It allows multi speed right angle gear box to be used in completely new applications, like variable ratio drive axle attached to front or rear axle, chainless transfer case, in bicycle or motorcycle transmissions and more. Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is an isometric view of coaxially mounded two spiral bevel gears in mesh with coaxially mounded two pinions.

FIG. 2 is an isometric view of coaxially mounded two face gears of enveloping worm face gear in mesh with two coaxial enveloping worms having threads with less than 90 degrees of revolution.

FIG. 3 is a side view of coaxially mounded two face gears of enveloping worm face gear in mesh with two coaxial enveloping worms having threads with less than 90 degrees of revolution.

FIG. 4 is an isometric view of the coaxially mounded two hypoid gears in mesh with two coaxial pinions, where first and second face gears have opposite teeth faces.

FIG. 5 is an isometric view of coaxially mounded two spiral bevel gears in mesh with two coaxial pinions with gear teeth faces facing in one direction and two spiral bevel gears in mesh with two coaxial pinions with gear teeth faces facing in opposite directions.

FIG. 6 is an isometric view of coaxially mounded face gears of enveloping worm face gear in mesh with two coaxial enveloping worms having threads with less than 90 degrees of revolution with gear teeth faces facing in one direction and two coaxially mounded face gears of enveloping worm face gears in mesh with two enveloping worms having threads with less than 90 degrees of revolution with gear teeth faces facing in opposite directions.

FIG. 7 is a side view of two coaxially mounded face gears of enveloping worm face gears in mesh with two coaxial enveloping worms having threads with less than 90 degrees of revolution with gear teeth faces facing in one direction and two coaxially mounded face gears of enveloping worm face gears in mesh with two enveloping worms having threads with less than 90 degrees of revolution with gear teeth faces facing in opposite directions.

FIG. 8 is an isometric view of coaxially mounded two spiral bevel gears in mesh with two coaxial pinions with gear teeth faces facing in one direction and two spiral bevel gears in mesh with two coaxial pinions having gear teeth faces facing in opposite directions and pinions opposing each other.

FIG. 9 is an isometric view of two coaxially mounded face gears of enveloping worm face gears in mesh with two coaxial enveloping worms having threads with less than 90 degrees of revolution with gear teeth faces facing in one direction and two coaxially mounded face gears of enveloping worm face gears in mesh with two enveloping worms having thread with less than 90 degrees of revolution with gear teeth faces facing in opposite directions and enveloping worms opposing each other.

FIG. 10 is a side view of two coaxially mounded face gears of enveloping worm face gears in mesh with two coaxial enveloping worms having threads with less than 90 degrees of revolution with gear teeth faces facing in one direction and two coaxially mounded face gears of enveloping worm face gears in mesh with two enveloping worms having threads with less than 90 degrees of revolution with gear teeth faces in opposite directions and enveloping worms opposing each other.

FIG. 11 is an isometric view of FIG. 8 with two additional coaxially mounded spiral bevel gears placed to the bottom of spiral bevel gears of FIG. 8.

FIG. 12 is an isometric view of FIG. 9 with two additional coaxially mounded face gears of enveloping face gears placed to the bottom of enveloping face gears of FIG. 9.

FIG. 13 is a side view of FIG. 9 with two additional coaxially mounded face gears of enveloping face gears placed to the bottom of enveloping face gears of FIG. 9.

FIG. 14 is an isometric view of enveloping worm gears.

FIG. 15 is a side view of enveloping worm gears.

FIG. 16 is an isometric view of coaxially mounded face gears of enveloping worm face gears and spiral bevel gear in mesh with coaxially enveloping worms having threads with less than 90 degrees of revolution and with spiral bevel gear pinion accordingly.

FIG. 17 is a side view of coaxially mounded face gear of enveloping worm face gears and spiral bevel gear in mesh with coaxial enveloping worms having threads with less than 90 degrees of revolution and with spiral bevel gear pinion accordingly.

FIG. 18 is an isometric view of coaxially mounded face gear of enveloping worm face gear transmission and worm gear of enveloping worm gear transmission in mesh with enveloping worms having threads with less than 90 degrees of revolution.

FIG. 19 is a side view of coaxially mounded face gear of enveloping worm face gear transmission and worm gear of enveloping worm gear transmission in mesh with enveloping worms having threads with less than 90 degrees of revolution.

FIG. 20 is an isometric view of coaxially mounded worm gear and hypoid gear in mesh with coaxial enveloping worm having threads with less than 90 degrees of revolution and with hypoid gear pinion accordingly.

FIG. 21 is a side view of coaxially mounded worm gear and hypoid gear of enveloping worm gear in mesh with coaxial enveloping worm having threads with less than 90 degrees of revolution and with hypoid gear pinion accordingly.

FIG. 22 is schematic view of gear reduction unit with two sets of face or bevel type gears.

FIG. 23 is a schematic view of gear reduction unit with two sets of face or bevel type gears and an additional pinion.

FIG. 24 is a schematic view of gear reduction unit with two sets of face or bevel type gears and additional set of a face or bevel type gear and a pinion.

FIG. 25 is a schematic view of gear reduction unit with four sets of face or bevel type gears.

FIG. 26 is a schematic view of gear reduction unit with four sets of face or bevel type gears.

FIG. 27 is a schematic view of gear reduction unit with two sets of face or bevel type gears and additional set of two face or bevel type gears.

FIG. 28 is schematic view of gear reduction unit with one set of worm gears.

FIG. 29 is schematic view of gear reduction unit with two sets of worm gears.

FIG. 30 is schematic view of gear reduction unit with two sets of face or bevel type gears and one set of enveloping worm face gears.

FIG. 31 is schematic view of gear reduction unit with one set of hypoid gears and one set of worm gears.

FIG. 32 is a schematic view of gear reduction unit with six sets of face or spiral bevel type gears.

FIG. 33 is a schematic view of gear reduction unit with two sets of face or bevel type gears with means having rotating type shift.

FIG. 34 is an isometric view of gear reduction unit with six sets of face or spiral bevel type gears.

FIG. 35 is a schematic view of a gear reduction unit in a front drive axle vehicle.

FIG. 36 is a schematic view of a gear reduction unit in a rear drive axle vehicle.

### DETAILED DESCRIPTION OF THE PREFERRED EMBODIMENTS

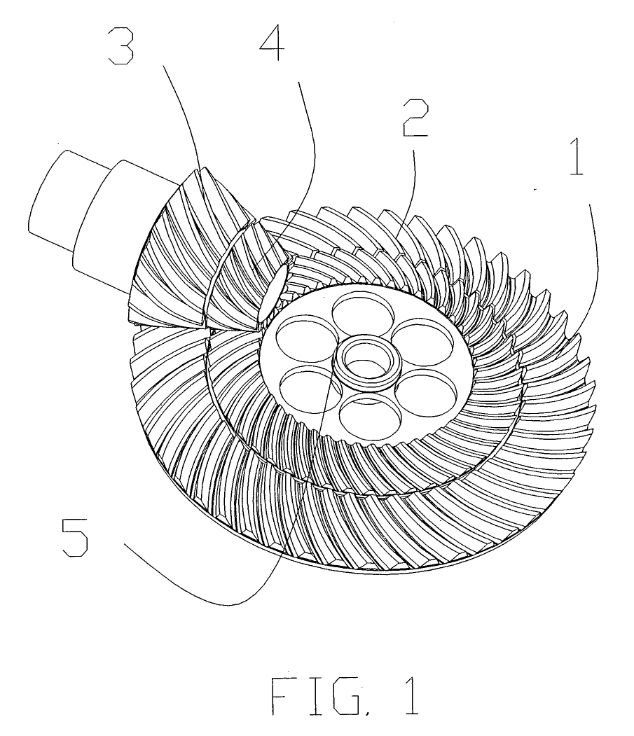

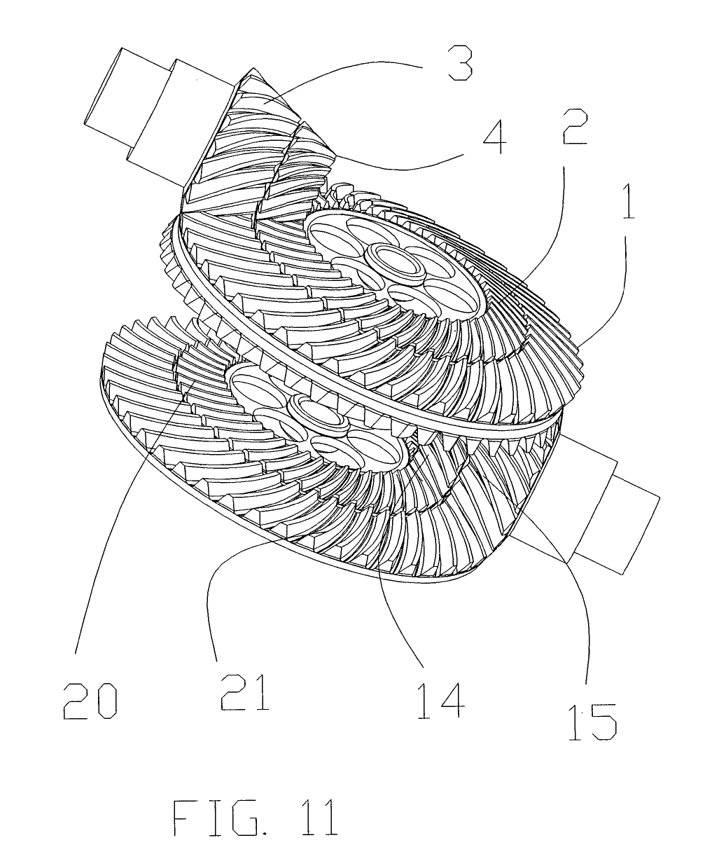

The following discussion relating to FIGS. 1-34 provides a detailed description of the unique gear reduction unit which can be utilized with the present invention.

More torque capacity is the main advantage for using the right angle gears. For various torque capacities and design requirements different right angle gear sets could be used. Spiral bevel gears and hypoid gears are bevel type right angle gears.

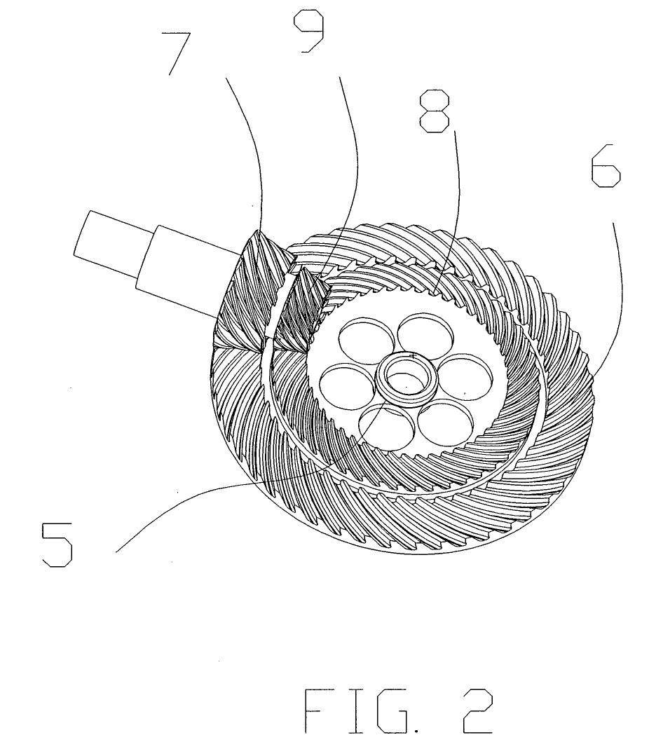

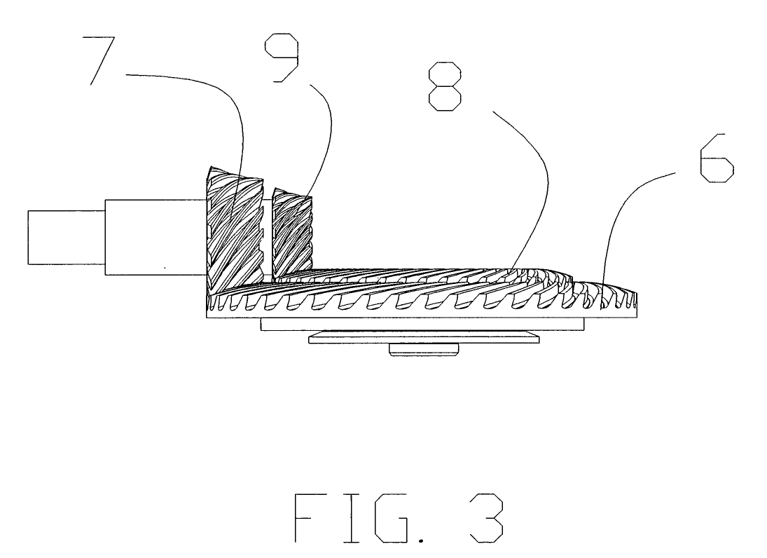

FIG. 1 is an isometric view of coaxially mounded first spiral bevel 1 and second spiral bevel gears 2 gears in mesh with coaxially mounded first pinion 3 and second pinion 4. Gears 1 and 2 connected to each other. Output member 5 of gears 1 and 2 may be linked to a source of mechanical energy or to a load. Pinions 3 and 4 are coaxially arranged in order to rotate independently to each other. Gears shown in FIG. 1 may be replaced with any face gears, like gears where the pinion is a regular worm or enveloping worm with less than 90 degrees of threads of revolution. FIG. 2 and FIG. 3 are isometric and side views of coaxially mounded and connected to each other face gears 6 and 7 of enveloping worm face gears in mesh with two coaxial enveloping worms 8 and 9 having threads with less than 90 degrees of revolution. The enveloping worm face transmission is new type of right angle gears (U.S. patent application Ser. No. 10/435,143) comprising a worm gear (face gear 6) and an enveloping worm 8. Said enveloping worm 8 having at least one screw thread that is engaged by at least one tooth of said worm gear 6 wherein said worm gear is a face gear and said enveloping worm 8 is placed into face arrangement with said worm gear 6. In this enveloping worm face transmission the enveloping worm 8 could have any design, however, it is preferred that the enveloping worm is utilized for standard enveloping or double enveloping worm /worm gear transmission. Pinions 7and 9 are coaxially arranged to rotate independently to each other.

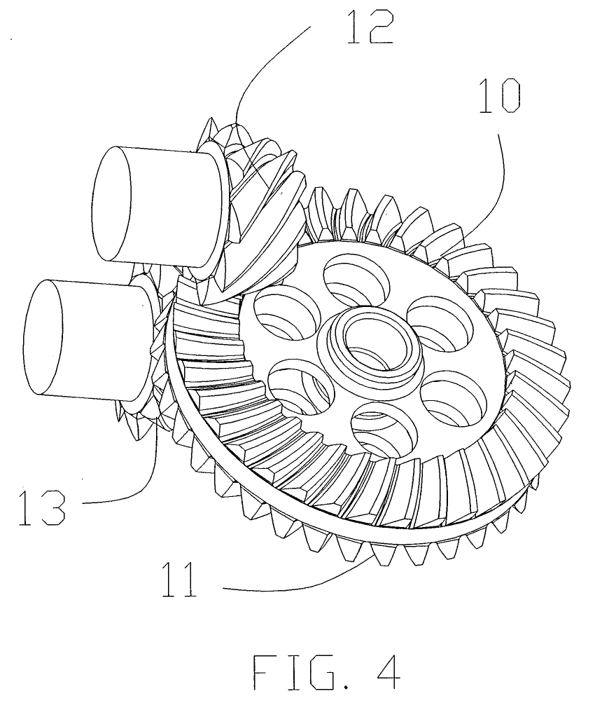

FIG. 4 is an isometric view of coaxially mounded and connected to each other hypoid gears 10 and 11 in mesh with two coaxial pinions 12 and 13, where first hypoid 10 and second hypoid 11 gears have teeth faces facing in opposite directions.

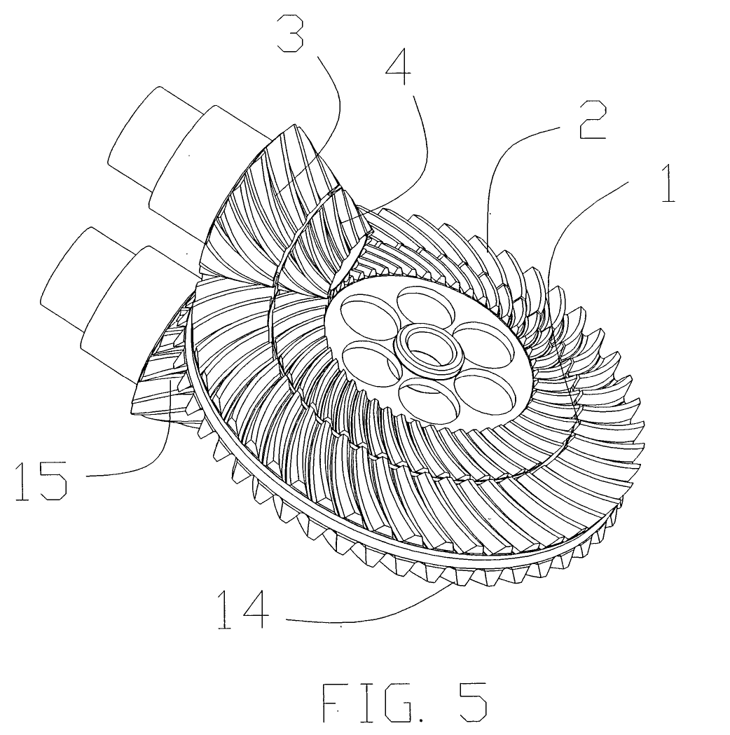

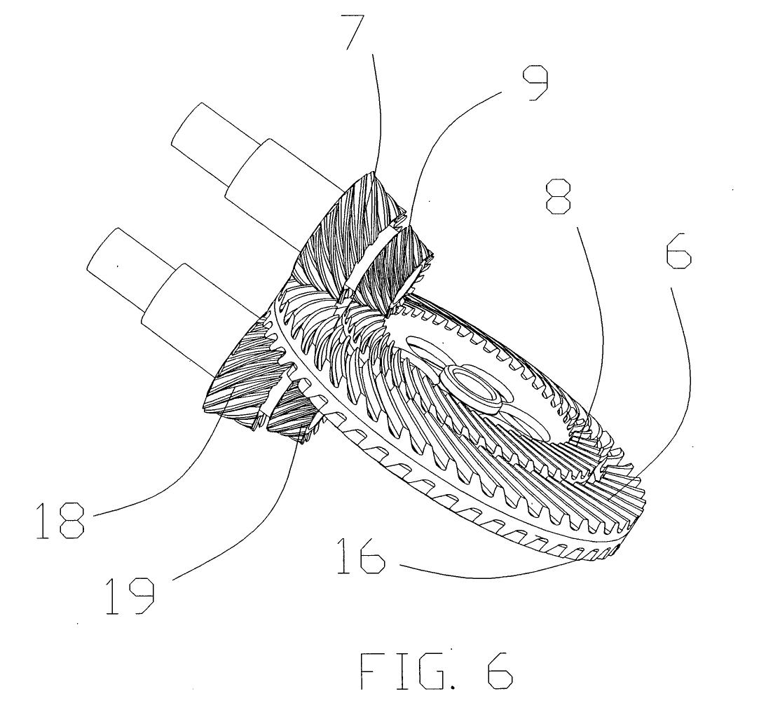

FIG. 5 is an isometric view of coaxially mounded and connected to each other spiral bevel gears 1 and 2 in mesh with two coaxial pinions 3 and 4 having gear teeth faces facing in one direction and spiral bevel gears 14 and another gear not shown in this view are in mesh with coaxial pinion 15 and with another pinion not shown in this view having gear teeth faces facing in opposite direction. This configuration of gears makes a very compact design of right angle reduction gears for using in 4 speed gear box. Position of not shown face gear in mesh with not shown pinion is illustrated in FIG. 7 showing the same relations between enveloping worm face gears and enveloping pinions.

FIG. 6 and FIG. 7 show the same relations between right angle gears and pinions like FIG. 5 where two coaxially mounded and connected to each other face gears 6 and 8 of enveloping worm face gears are in mesh with two coaxial enveloping worms 7 and 9 having threads with less than 90 degrees of revolution with gear teeth faces facing in one direction and two coaxially mounded and connected to each other face gears 16 and 17 of enveloping worm face gears in mesh with two enveloping worms 18 and 19 having threads with less than 90 degrees of revolution with gear teeth faces facing in opposite directions.

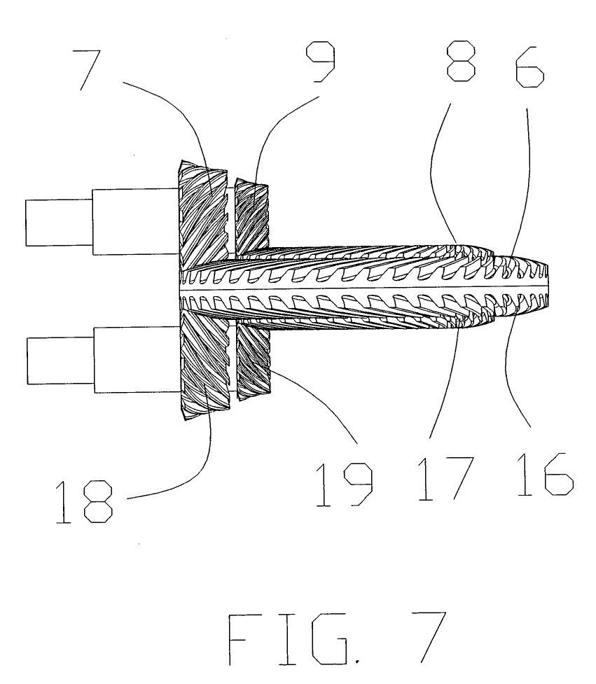

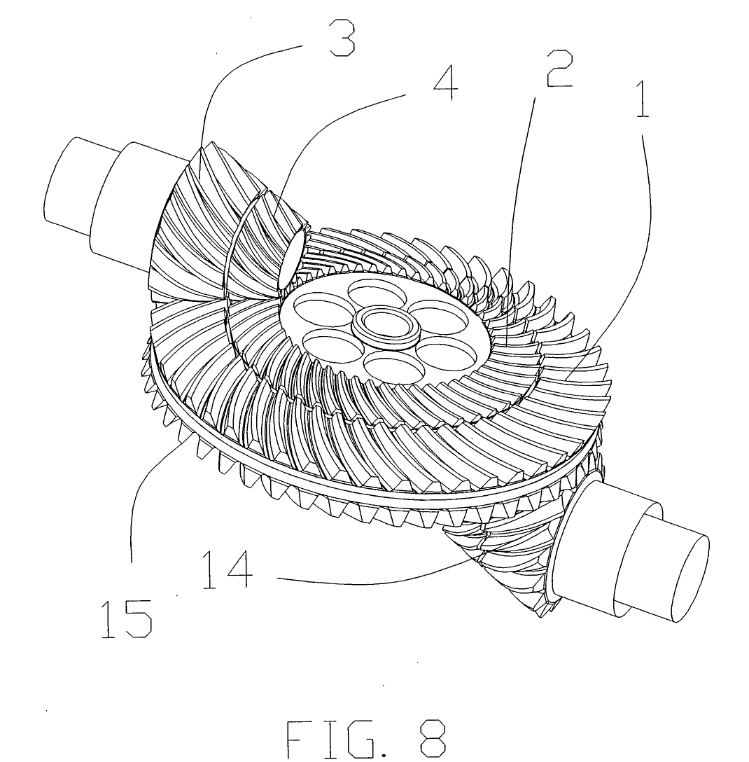

FIG. 8 is the same as FIG. 5, but the only difference is that pinions are on opposite sides of the gear. Advantage of such layout is that all pinions rotate in the same direction. By changing location of mesh between a gear and a pinion we can change direction of rotation of pinion or the gear.

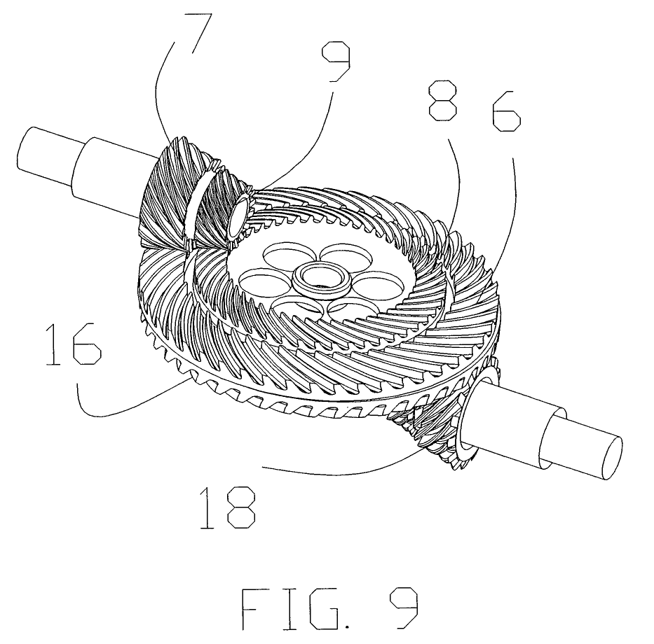

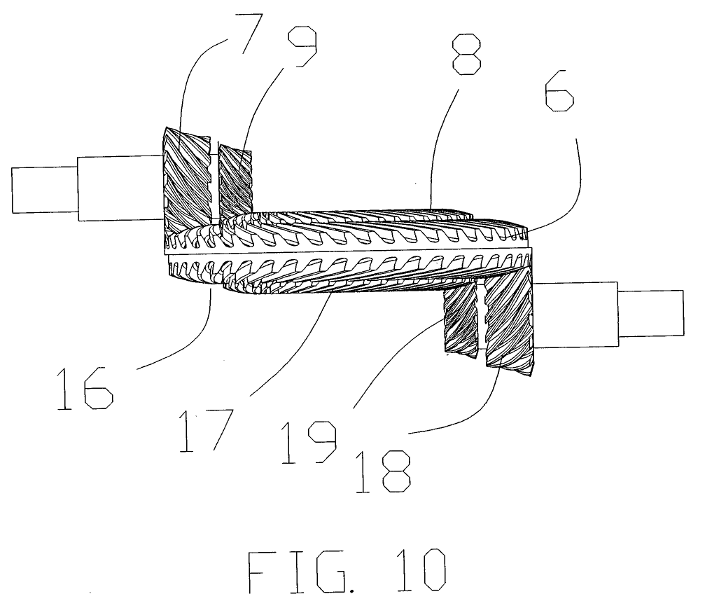

FIGS. 9 and 10 are the same FIGS. 6 and 7, but the only difference is that pinions are on opposite sides of the gear. Advantage of such layout is that all pinions rotate in the same direction. By changing location of mesh between a gear and a pinion we can change direction of rotation of pinion or the gear.

In addition to FIG. 8, FIG. 11 has two spiral bevel gears 20 and 21 that are in mesh with pinions 14 and 15. These gears rotate in opposite direction compared to direction of rotation of gears 1 and 2.

In additional to FIGS. 9 and 10, FIGS. 12 and 13 have two enveloping worm face gears 22 and 23 that are in mesh with pinions 18 and 19. These gears rotate in opposite direction compare to direction of rotation of gears 6 and 8.

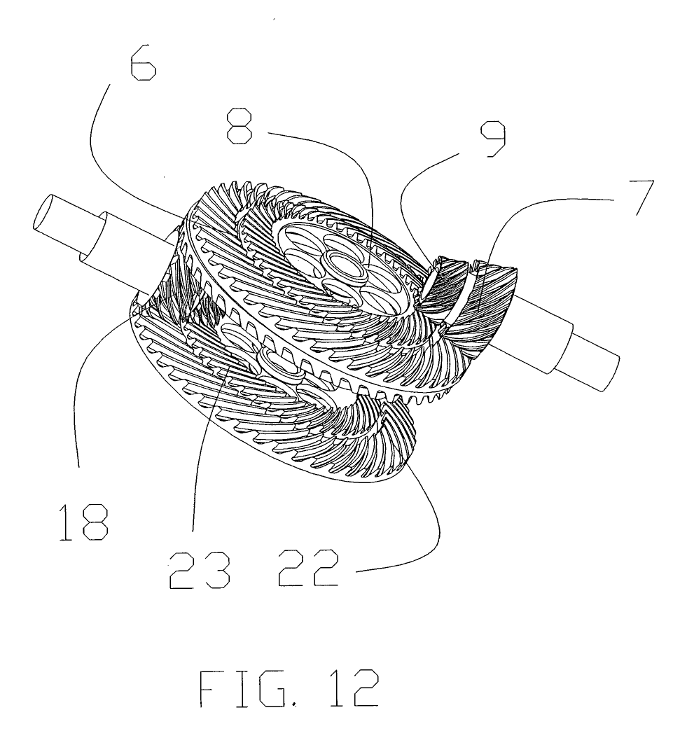

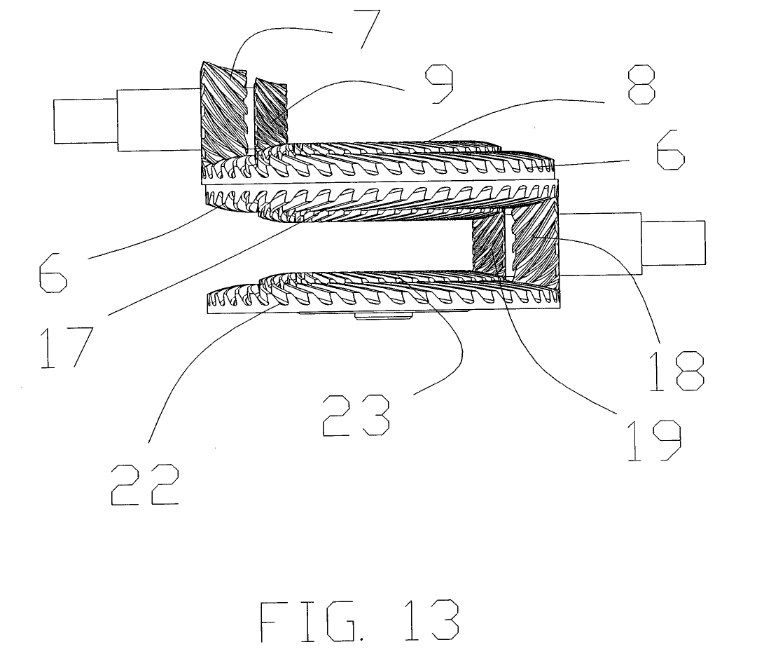

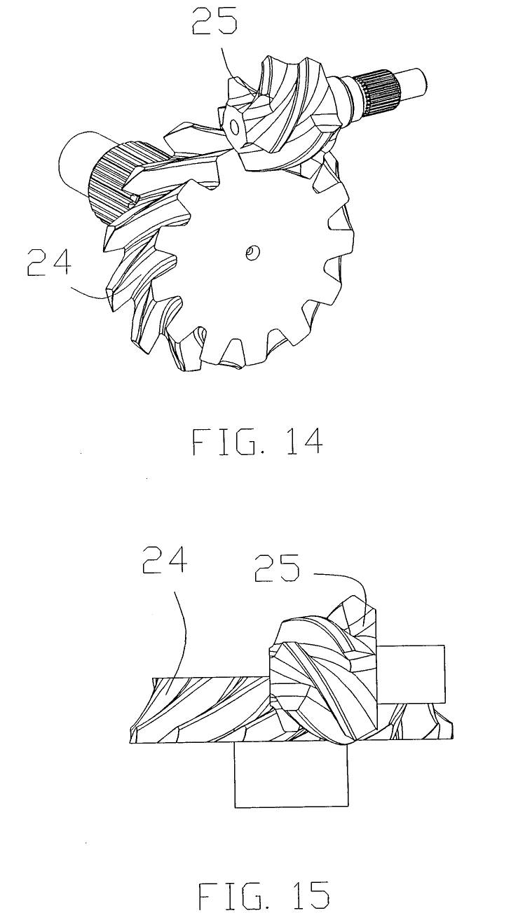

FIG. 14 is an isometric view of enveloping worm transmission showing a mesh of worm gear 24 with worm 25, where enveloping worm 25 has threads with less than 90 degrees of revolution.

FIG. 15 is a side view of enveloping worm transmission showing a mesh of worm gear 24 with worm 25, where enveloping worm 25 has threads with less than 90 degrees of revolution. These types of gears are described in my U.S. Pat. No. 6,148,683.

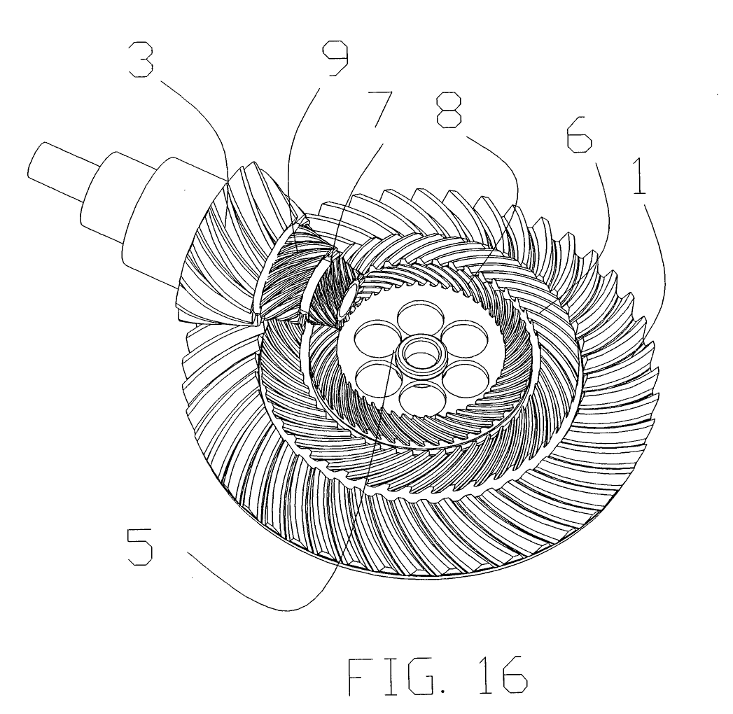

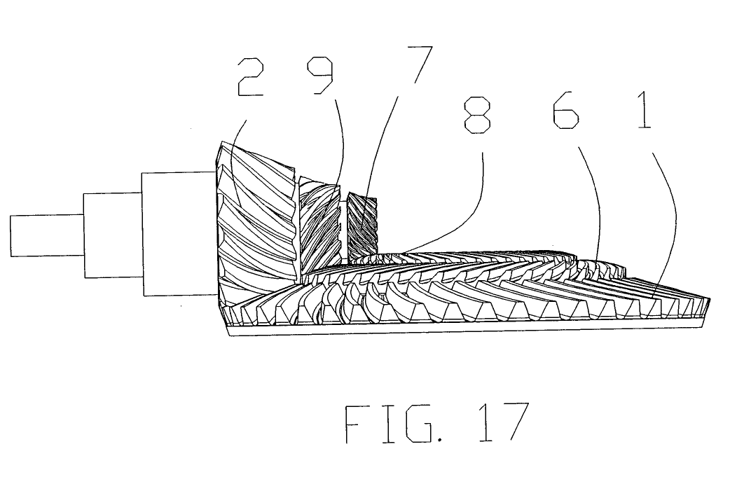

FIGS. 16 and 17 are views of the coaxially mounded and connected to each other face gears 6 and 8 of enveloping worm face gears and spiral bevel gear 1 in mesh with coaxially enveloping worms 7 and 9 having threads with less than 90 degrees of revolution and with spiral bevel gear pinion 3 accordingly. Middle face gear 6 has curved teeth directed in the opposite direction compared to gears 1 and 8 and makes a herringbone gear. It can be used to reduce reaction load on the shafts and bearings. The same applies to the enveloping pinion 9, where thread direction is opposite of thread directions of pinion 2 and 7. FIGS. 16 and 17 illustrate more than two sets of right angle gears where gears are connected to each other. It could be combination of different types of gears like spiral bevel, hypoid, or any face gears.

FIGS. 18 and 19 are views of coaxially mounded face gear 6 of enveloping worm face gear in mesh with pinion 7 and worm gear 24 of enveloping worm gear in mesh with pinion 25. Gears 6 and 24 are connected to each other. Pinions 7 and 25 are enveloping worms having threads with less than 90 degrees of revolution.

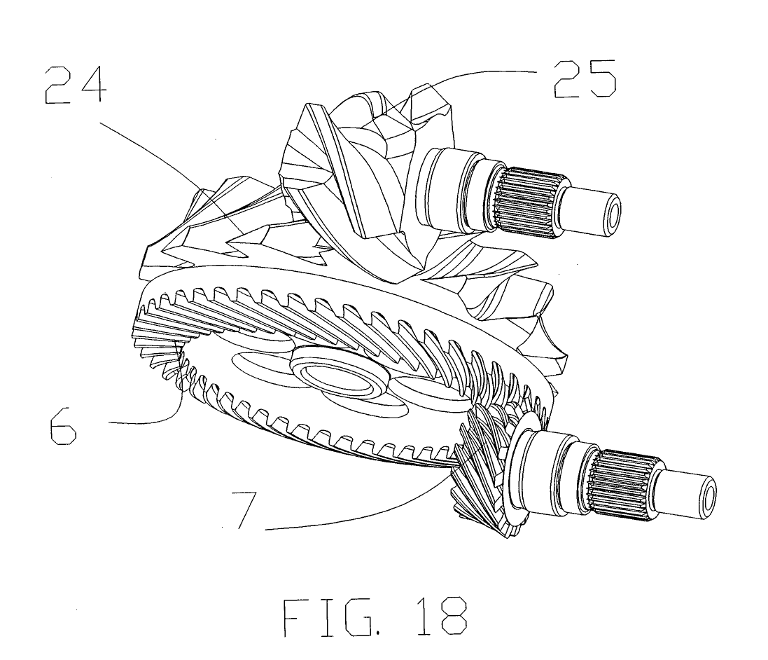

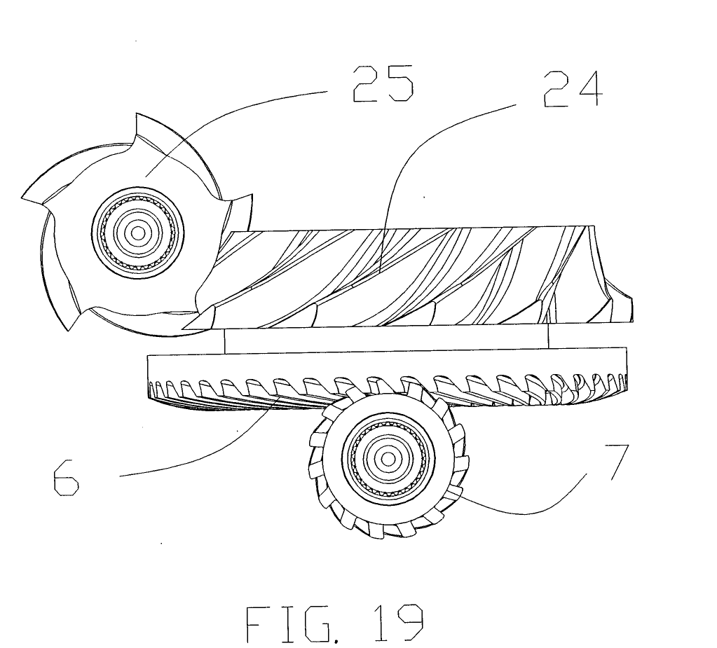

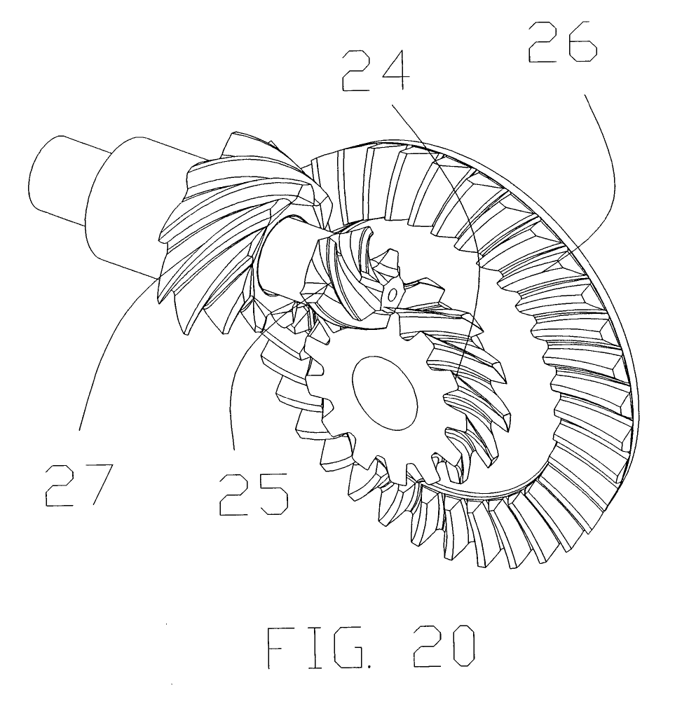

FIGS. 20 and 21 are views of coaxially mounded worm gear 24 and hypoid gear 26 of enveloping worm gear in mesh with coaxial enveloping worm 25 having threads with less than 90 degrees of revolution and with hypoid gear pinion 27 accordingly. Gears 24 and 26 are connected to each other.

For schematic illustration we are using a pair of enveloping worm face gears; however they could be replaced with any combination of gears described above in FIG. 1-FIG. 21.

FIG. 22 is a schematic view of a gear reduction unit with two sets of face or bevel type gears. Means 28 for distinct connection of first pinion 7 or second pinion 9 to shaft 29 could be any device that is usually used in constant mesh gearboxes. Such device typically includes shift mechanism with sliding dog clutch or electromagnetic clutch or synchromesh shift mechanism. Shaft 29 is linked to a source of mechanical energy or to a load.

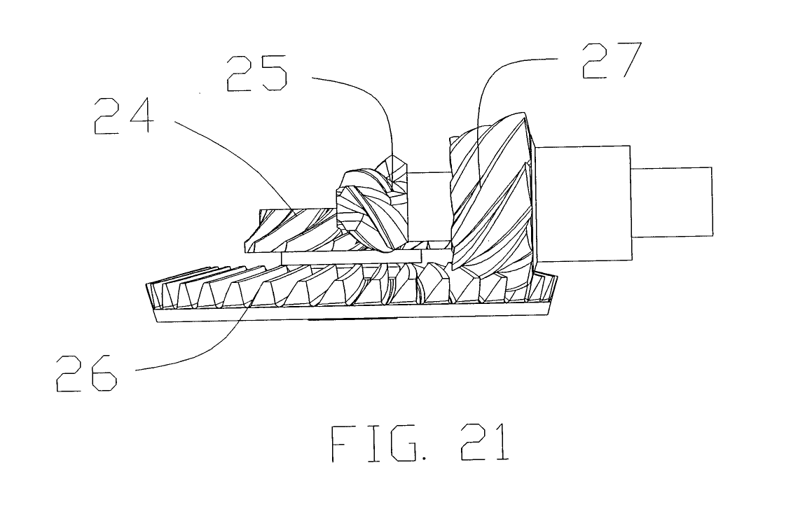

FIG. 23 is a schematic view of a gear reduction unit with two sets of face or bevel type gears 6,7,8,9 and additional pinion 30. This pinion could be used for reverse output motion.

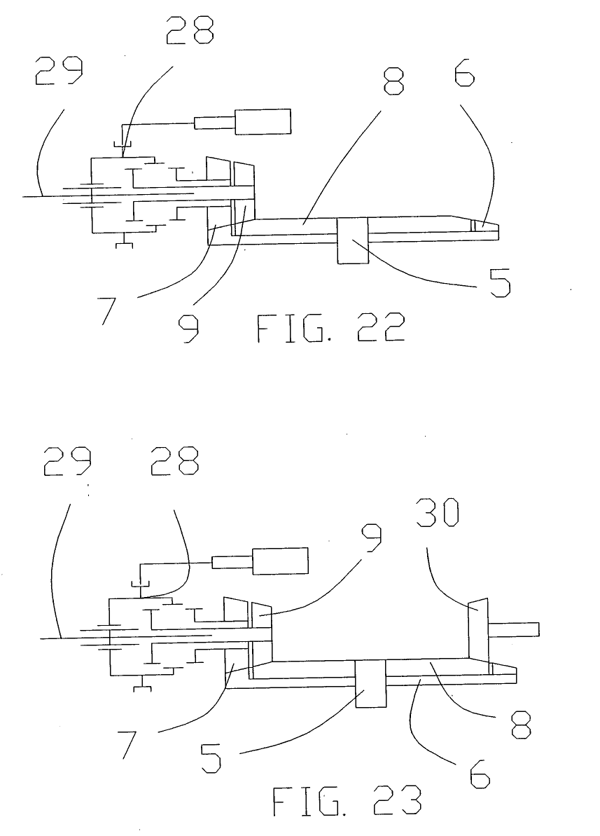

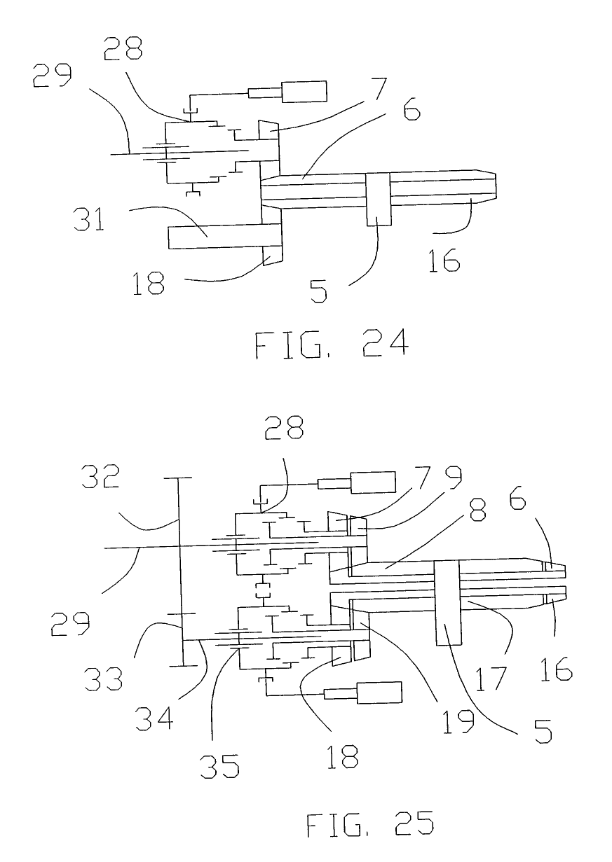

FIG. 24 is a schematic view of gear reduction unit with two face or bevel type gears 6 and 7 and additional face or bevel type gear 16 and pinion 18 having shaft 31 for convenient connection with additional load. Schematic in FIG. 24 could be used in transfer case of four wheel drive vehicles, where shaft 29 connected to the vehicle's transmission (not shown) pinion's 7 shaft is expedient to the rear drive axle and additional pinion's 18 shaft 31 is connected to the front drive axle.

FIG. 25 is a schematic view of a gear reduction unit with four sets of face or bevel type gears. It uses parallel shaft gears 32 and 33 to supply motion to the additional set of two right angle gears with gears 16 and 17 in mesh with pinions 18 and 19. A specific ratio between gears 29 and 33 may increase speed of shaft 34. Means 35 for distinct connection of first pinion 18 or second pinion 19 to shaft 34 also could be any device that is usually used in constant mesh gearboxes. This device typically includes shift mechanism with sliding dog clutch or electromagnetic clutch or synchromesh shift mechanism. The ratio between pinion 18 and gear 16 or the ratio between pinion 19 and gear 17 may be chosen to provide output member with the same speed as shaft 29's speed or even higher speed. In vehicle's transmission it provides direct drive or overdrive motion speed.

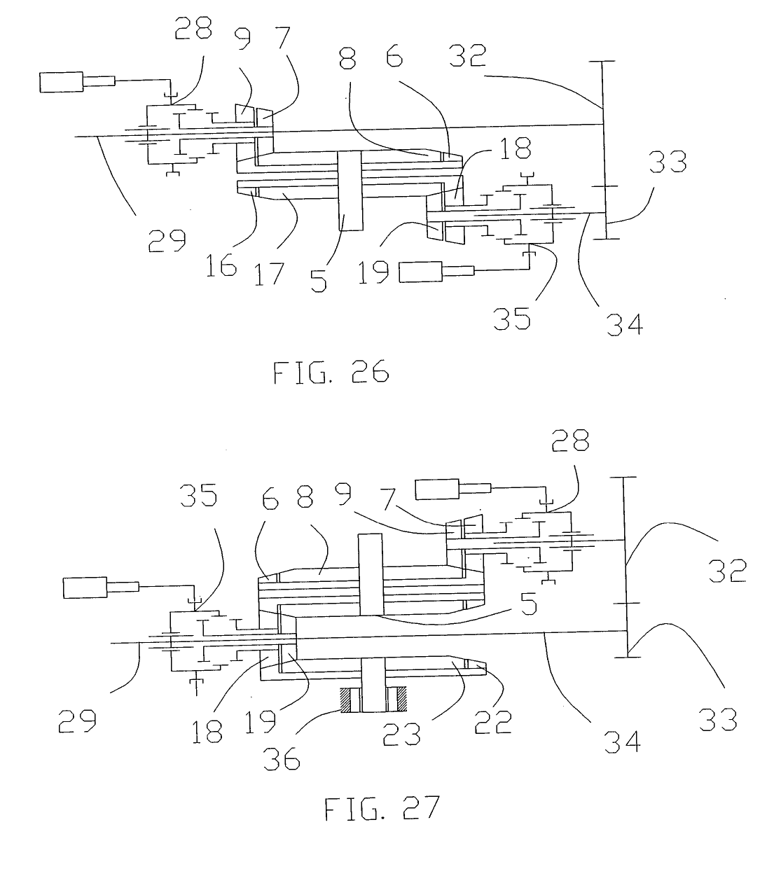

FIG. 26 is a schematic view of a gear reduction unit with four sets of face or bevel type gears similar to FIG. 25 but with an opposite position of pinions 18 and 19, gears 32 and 33, shaft 34, and means 35.

FIG. 27 in addition to FIG. 25 has an additional set of two face or bevel type gears 22 and 23 in mesh with pinions 18 and 19. Entire set of gears may be grounded by applying force from brake 36.

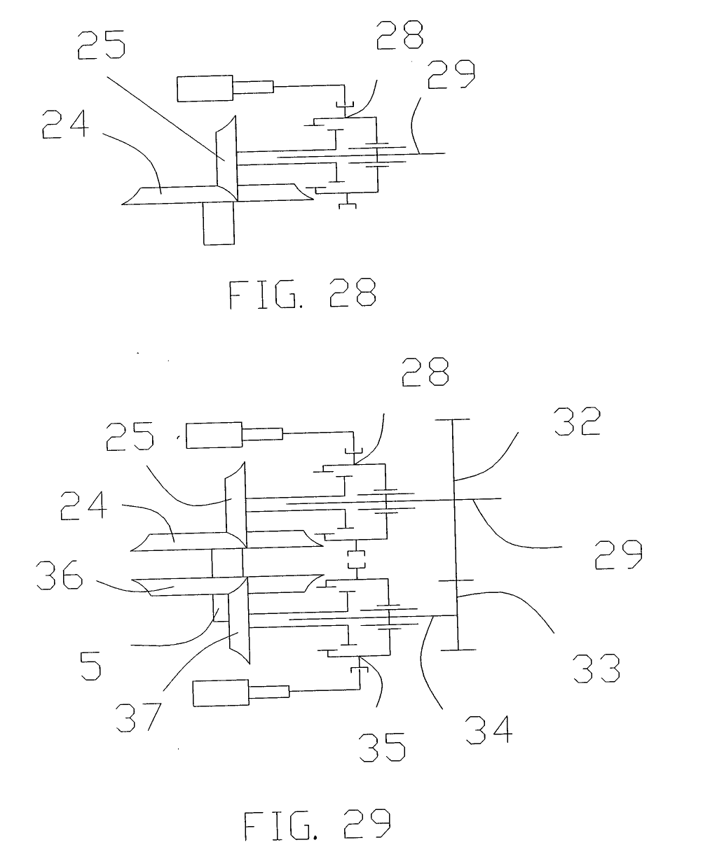

FIG. 28 is schematic view of a gear reduction unit with one set of worm gears 24 and 25.

FIG. 29 is schematic view of gear reduction unit with two sets of worm gears 24, 25 and 36, 37 where gears 24 and 36 are coaxially arranged and connected to each other.

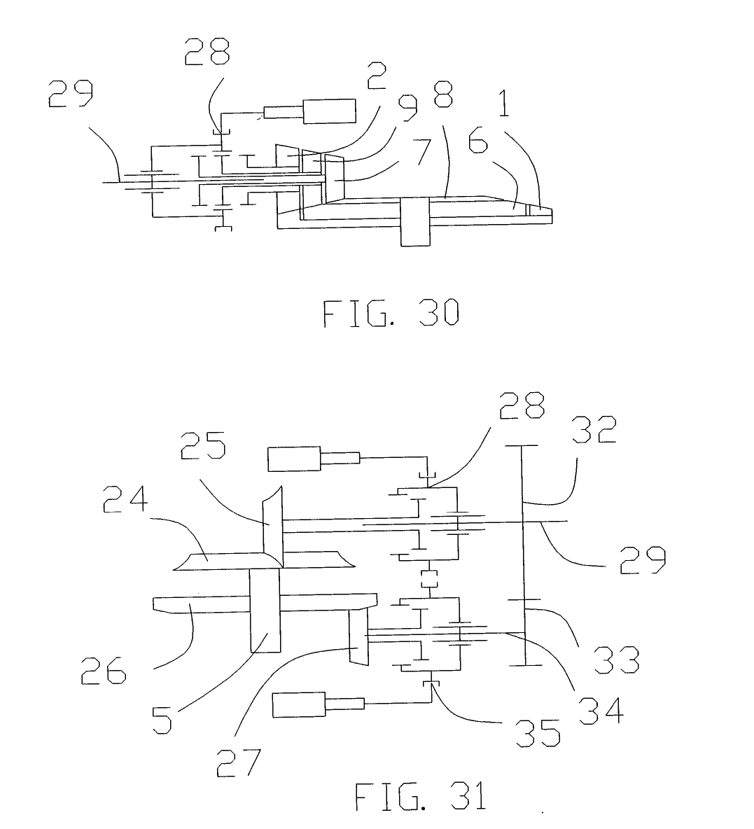

FIG. 30 is schematic view of a gear reduction unit with three sets of face or bevel type gears. Gears 1, 6 and 8 are coaxially arranged and connected to each other. This design could be used in a three speed gear box, like that of a bicycle or a motorcycle.

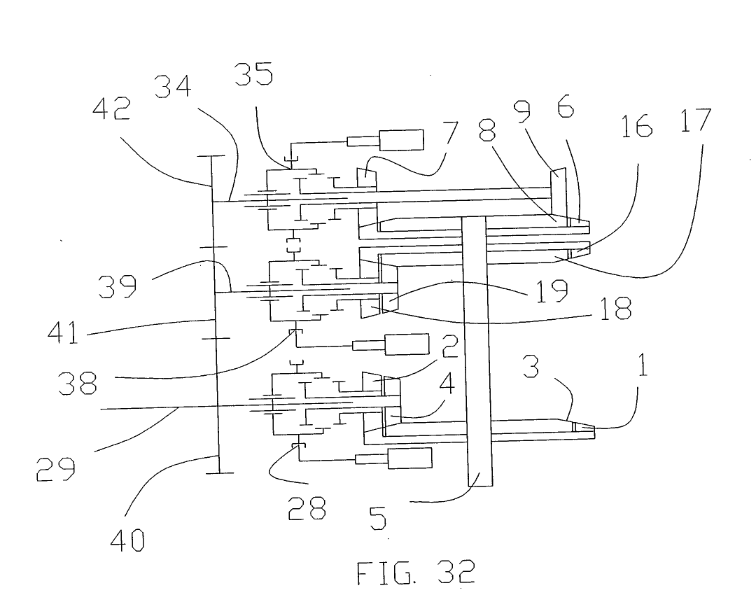

FIG. 31 is schematic view of a gear reduction unit with one set of hypoid gears 26, 27 and one set of worm gears 24, 25. Pinions 25 and 27 could be coaxially arranged to rotate independently of each other as shown in FIGS. 20 and 21. In FIG.31 pinions 25 and 27 are shown on separate axes of rotation.

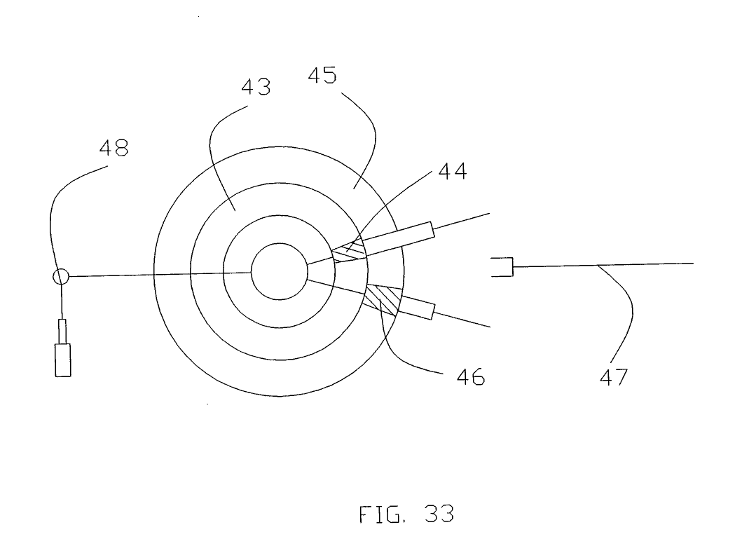

FIG. 32 is a schematic view of a gear reduction unit with three sets of face or spiral bevel type gears. It has gear 1, 3, 6, 8, 16, 17 in mesh with pinion 2, 4, 7, 9, 18, 19 accordingly. Each pair of gears is controlled by independent means connecting to source of power or load. Gears 1,2,3,4 are controlled by means 28, gears 6,7,8,9 are controlled by means 35, and gears 16, 17, 18, 19 are controlled by means 38. Means 28 connect pinions 2 and 4 to shaft 29; means 35 connect pinions 7 and 9 to shaft 34; means 38 connect pinions 18, 19 to shaft 39. Gears 40, 41 and 42 distribute motion from shaft 29 to shafts 34 and 39. FIG. 32 may be used to design five speed manual or automatic vehicle transmission, where gears 8 and 9 will be used for reverse motion. To avoid output shaft 5 from crossing pinion 9, gears 6 and 8 with pinions 7 and 9 can be offset gears, like hypoid.

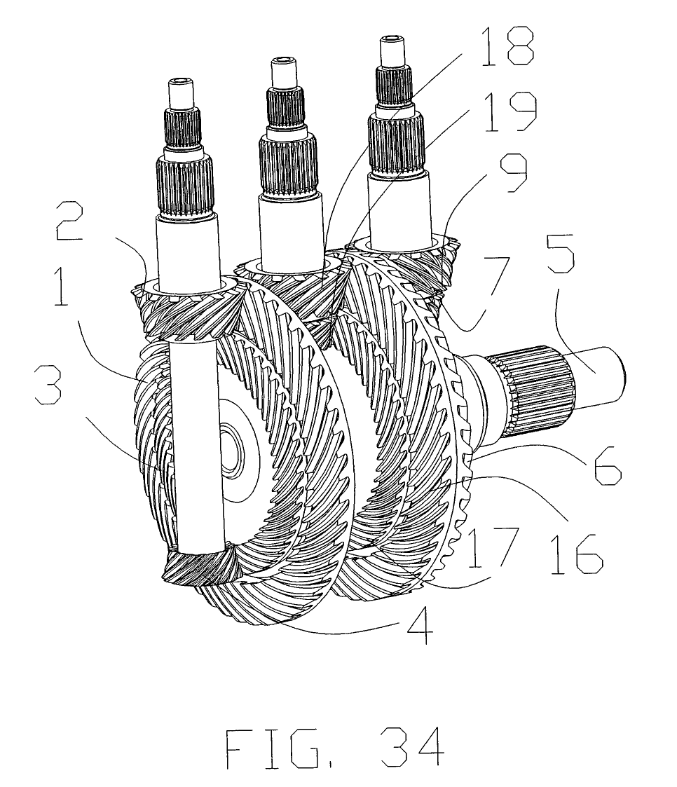

FIG. 33 is a schematic view of gear reduction unit with two sets of faces or bevel type gears 43, 45 in mesh with pinion 44, 46 accordingly. Connection of pinion 44 and 46 to shaft 47 is possible by rotating type of shift means 48. It rotates pinions around the axis of rotation of gears 43 and 45, allowing pinion 44 to connect to shaft 47 or pinion 46 to shaft 47.

FIG. 34 is an isometric view of a gear reduction unit with six sets gears of a schematic view shown in FIG. 32.

Gear reduction unit works like any gear reduction unit with constant gear mesh. By means according with desired ratio it connects the chosen pinion to a shaft linking to source of energy or load. Gear reduction unit transfers power from shaft 29 to shaft 5 or from shaft 5 to shaft 29.

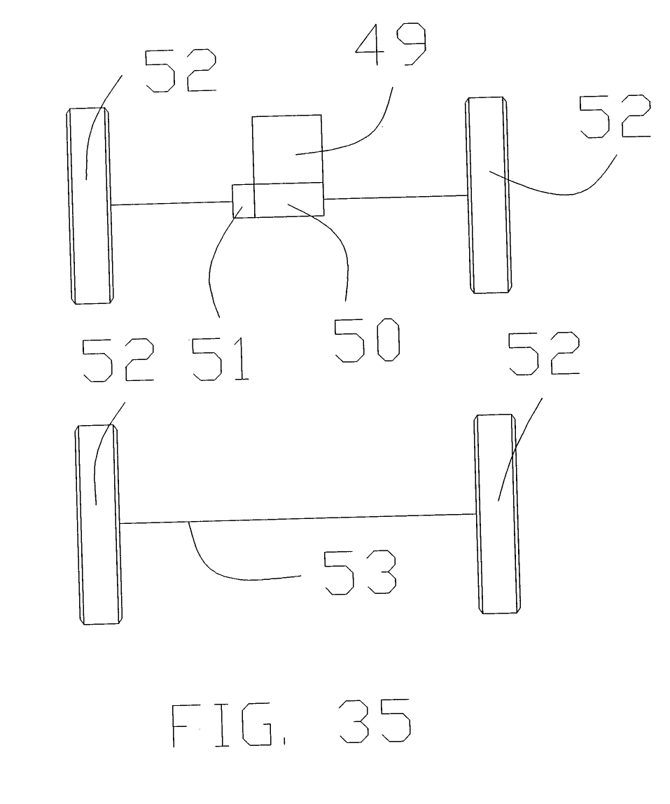

FIG. 35 is a schematic view of gear reduction unit in a front drive axle vehicle, where engine 49 is attached to gear reduction unit 50 according with FIG. 32. Gear reduction unit 50 is connected to a traction system (differential) 51. Traction system 51 is connected to front axle with tires 52.

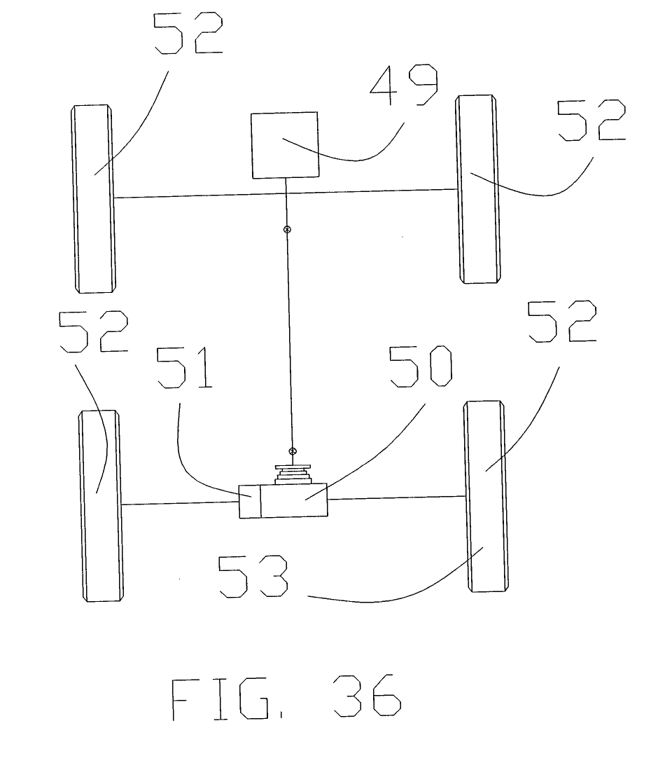

FIG. 36 is a schematic view of a gear reduction unit in a rear drive axle vehicle, where engine 49 is attached to gear reduction unit 50 according with FIG. 32. Gear reduction unit 50 is connected to traction system (differential) 51. Traction system 51 is connected to rear axle with tires 53. This type of layout eliminates front or rear drive axle.

The reduced noise of the right angle gears, especially enveloping worm face transmission compared to any parallel shaft gears make using the present invention more beneficial, particularly in helicopter or in motor vehicle power train applications.

For the same size of gears, this invention can provide up to twice the torque capacity of any parallel shaft transmissions.

Taped shape of the bevel type gears allows the use of very productive technology, like forging, or casting.

The basic inventive system of the present invention can be reconfigured into many different mechanical transmissions. For example, it can be used in a compact multi speed vehicle transaxle, integrated transmission and front axle car drive, integrated transmission and rear axle car drive, escalator drive, and more. The gear reduction unit described above can be utilized in a new layout of four-wheel vehicles.

### General Advantages of Gear Reduction Unit

The above described gear reduction unit transmits more power with smaller size. It is a compact alternative for spur or planetary transmissions in many applications, especially mobile.

The invention has high torque capacity due to the use of right angle gears with more power density. It applies even more when using enveloping worm face gears or enveloping worm gears with worm having threads with less than 90 degrees of revolution. In enveloping worm face gears contact pattern has motion along the tooth line: from left to right or from right to left depending on the direction of rotation. In hypoid or spiral bevel gears contact pattern has motion across the tooth: from the root to the tip or from the tip to the root depending on the direction of rotation. Enveloping gear has better lubrication condition (suction vs. squeezing out) that increase driving efficiency.

In automotive power train applications like front and rear drive axles, power take-off units, traction systems and mechanical amplifiers it saves up to 30% of space and significantly reduces weight. It will work in power windows and power seats, and steering drives.

Most of the time each thread (pinion tooth) of right angle gears is in mesh longer than any other pinion of parallel or planetary gears. It reduces impact of engagement and disengagement, increases the contact ratio and makes quieter motion.

Using existing gear cutting machines and forging or casting technology can make right angle gears cheaper to manufacture. There are very broad opportunities for the right angle gears made from plastic.

In the invention being thus described, it is obvious that the same may be varied in many ways. Such variations are not to be regarded as a departure from the spirit and scope of the invention, and all such modifications as would be obvious to one skilled in the art are intended to be included within the scope of the following claims.

1. Gear reduction unit comprising:
a first gear of first right angle pair of gears;
a second gear of second right angle pair of gears;
said first and second gears coaxially arranged and connected to each other;
a first pinion in meshing engagement with the first gear;
a second pinion in meshing engagement with the second gear;
a shaft;
means for distinct connection of first pinion to the shaft.

2. Gear reduction unit as recited in claim 1 wherein the first pinion and second pinion are coaxially arranged to rotate independently to each other.

3. Gear reduction unit as recited in claim 1 wherein the first right angle pair of gears are bevel type gears and second right angle pair of gears are bevel type gears.

4. Gear reduction unit as recited in claim 1 wherein the first right angle pair of gears are worm gears and second right angle pair of gears are worm gears.

5. Gear reduction unit as recited in claim 1 wherein the first right angle pair of gears are face gears and second right angle pair of gears are face gears.

6. Gear reduction unit as recited in claim 1 wherein the first right angle pair of gears are bevel type gears and second right angle pair of gears are worm gears.

7. Gear reduction unit as recited in claim 1 wherein the first right angle pair of gears are bevel type gears and second right angle pair of gears are face gears.

8. Gear reduction unit as recited in claim 1 wherein the first right angle pair of gears are worm gears and second right angle pair of gears are face gears.

9. Gear reduction unit as recited in claim 1 wherein the first gear and second gear have teeth faces facing in opposite directions;

10. Gear reduction unit as recited in claim 1 wherein said means are distinctly connecting first and second pinions to the shaft.

11. Gear reduction unit comprising:
a first gear of first right angle pair of gears;
a second gear of second right angle pair of gears;
a third gear of third right angle pair of gears;
said first, second and third gears coaxially arranged and connected to each other;
a first pinion in meshing engagement with the first gear;
a second pinion in meshing engagement with the second gear;
a third pinion in meshing engagement with the third gear;
a shaft;
means for distinct connection of first, second and third pinions to the shaft.

12. Gear reduction unit as recited in claim 11 wherein the first pinion and the second pinion are coaxially arranged to rotate independently to each other.

13. Gear reduction unit as recited in claim 11 wherein the first right angle pair of gears are bevel type gears and second right angle pair of gears are bevel type gears.

14. Gear reduction unit as recited in claim 11 wherein the first right angle pair of gears are worm gears and second right angle pair of gears are worm gears.

15. Gear reduction unit as recited in claim 11 wherein the first right angle pair of gears are face gears and second right angle pair of gears are face gears.

16. Gear reduction unit as recited in claim 11 wherein the first right angle pair of gears are bevel type gears and second right angle pair of gears are worm gears.

17. Gear reduction unit as recited in claim 11 wherein the first right angle pair of gears are bevel type gears and second right angle pair of gears are face gears.

18. Gear reduction unit as recited in claim 11 wherein the first right angle pair of gears are worm gears and second right angle pair of gears are face gears.

19. Gear reduction unit as recited in claim 11 wherein the first gear and the second gear have teeth faces facing in opposite directions.

20. Gear reduction unit comprising:
a first gear of first right angle pair of gears;
a second gear of second right angle pair of gears;
a third gear of third right angle pair of gears;
a fourth gear of fourth right angle pair of gears;
said first, second, third and fourth gears coaxially arranged and connected to each other;
a first pinion in meshing engagement with the first gear;
a second pinion in meshing engagement with the second gear;
a third pinion in meshing engagement with the third gear;
a fourth pinion in meshing engagement with the fourth gear;
a shaft;
means for distinct connection of first, second, third and fourth pinions to the shaft.

21. Gear reduction unit as recited in claim 20 wherein the first gear and the second gear have teeth faces facing in opposite directions.
